(19) United States
(12) Patent Application Publication
(10) Pub. No.: US 2026/0157933 A1
(43) Pub. Date: Jun. 11, 2026

(54) MEDICATION SUPPORT APPARATUS

(71) Applicants: Yu Yamaya, Gifu (JP); Terumitsu Azuma, Chiba (JP); Yoshihide Sugiyama, Gifu (JP); Hiroshi Fujie, Aichi (JP); Manabu Yamanaka, Aichi (JP); Takato Mochizuki, Kanagawa (JP); Takumi Hagiwara, Aichi (JP); Youhei Niitsuma, Kanagawa (JP); Sachika Tashiro, Kanagawa (JP)

(72) Inventors: Yu Yamaya, Gifu (JP); Terumitsu Azuma, Chiba (JP); Yoshihide Sugiyama, Gifu (JP); Hiroshi Fujie, Aichi (JP); Manabu Yamanaka, Aichi (JP); Takato Mochizuki, Kanagawa (JP); Takumi Hagiwara, Aichi (JP); Youhei Niitsuma, Kanagawa (JP); Sachika Tashiro, Kanagawa (JP)

(73) Assignee: ETRIA Co., Ltd., Kanagawa (JP)

(21) Appl. No.: 19/397,586

(22) Filed: Nov. 21, 2025

(30) Foreign Application Priority Data
Dec. 6, 2024 (JP) 2024-213739

(51) Int. Cl. A61J 7/00; G01V 8/26

(52) U.S. Cl. CPC A61J 7/0069; G01V 8/26; A61J 2200/70

(57) ABSTRACT

A medication support apparatus includes a sensor to detect whether a medicine pack to be inserted into a medicine tray associated with the medicine pack is in a detection field including an upstream area in an insertion direction of the medicine pack over an insertion slot of a medicine tray.

### CROSS-REFERENCE TO RELATED APPLICATION

This patent application is based on and claims priority pursuant to 35 U.S.C. § 119(a) to Japanese Patent Application No. 2024-213739, filed on Dec. 6, 2024, in the Japan Patent Office, the entire disclosure of which is hereby incorporated by reference herein.

### BACKGROUND

### Technical Field

The present disclosure relates to a medication support apparatus.

### Background Art

In medication support apparatuses, a medicine pack is inserted into the medicine tray associated with that medicine pack and is appropriately placed therein.

In such medication support apparatuses, for example, a medicine dispensing operation is performed. More specifically, a medicine pack that has been picked up from a container is conveyed to an associated room of a medicine dispensing tray that is an example of a medicine tray and is appropriately placed therein. In such medication support apparatuses, a medicine dispensing tray is provided with medicine-pack sensors that are an example of a sensor and are composed of reflection optical sensors to detect the medicine packs inserted into the rooms of the medicine dispensing tray. Such medication support apparatuses check that the medicine-pack sensors have detected medicine packs after medicine packs are dispensed to and arranged in empty rooms and a medicine dispensing operation is completed. By so doing, it can be confirmed that packs have been dispensed normally.

### SUMMARY

The present disclosure described herein provides a medication support apparatus including a sensor to detect whether a medicine pack to be inserted into a medicine tray associated with the medicine pack is in a detection field including an upstream area in an insertion direction of the medicine pack over an insertion slot of a medicine tray.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A is a schematic front view of a medication support apparatus in its entirety.

FIG. 1B is a schematic side view of the medication support apparatus of FIG. 1A.

FIG. 2A is a vertical sectional view of a cartridge placed in the medication support apparatus of FIG. 1A or FIG. 1B.

FIG. 2B is a bottom view of the cartridge of FIG. 2A.

FIG. 3 is a control block diagram illustrating a schematic control structure for a medication support apparatus.

FIG. 4A, FIG. 4B, FIG. 4C, FIG. 4D, FIG. 4E, and FIG. 4F are front views of a pickup device in the medication support apparatus of FIG. 1A or FIG. 1B, illustrating the progression of the operation of the pickup device.

FIG. 5A and FIG. 5B are front views of a pickup device in the medication support apparatus of FIG. 1A or FIG. 1B, illustrating the progression of the operation of the pickup device continued from FIG. 4F.

FIG. 6 is a flowchart of the sequence of basic operations of the medication support apparatus of FIG. 1A or FIG. 1B.

FIG. 7 is a flowchart of the processes of moving a home position (HP), which is a subroutine program of FIG. 6.

FIG. 8 is a supplemental flowchart of the operation of a pickup device in the medication support apparatus of FIG. 1A or FIG. 1B.

FIG. 9 is a diagram illustrating the control blocks of a medication support system.

FIG. 10 is a schematic perspective view of a pack sensor in the medication support apparatus of FIG. 1A or FIG. 1B.

FIG. 11 is a diagram illustrating a phototransmitter of the pack sensor of FIG. 10 viewed in its optical-axis direction.

FIG. 12A is a schematic diagram of a subdivision box where a medicine pack is placed inside appropriately.

FIG. 12B is a schematic diagram of a medicine pack sticking out from an insertion slot of a subdivision box.

FIG. 13 is a schematic diagram of a reflection optical sensor adopted as a pack sensor.

FIG. 14 is a flowchart of positioning error determination processes performed by a determination processor of a controller.

FIG. 15 is a diagram illustrating how pack sensors are arranged in a pair of medicine dispensing trays.

FIG. 16 is another diagram illustrating how pack sensors are arranged in a pair of medicine dispensing trays.

FIG. 17 is a diagram illustrating an example configuration in which a pair of pack sensors sequentially move to detecting positions in a plurality of columns.

FIG. 18 is a diagram illustrating an example configuration in which a pair of light-curtain sensors are adopted as a pack sensor.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Embodiments of the present disclosure are described in detail below with reference to the drawings. First, a medication support apparatus that makes up a medication support system is described.

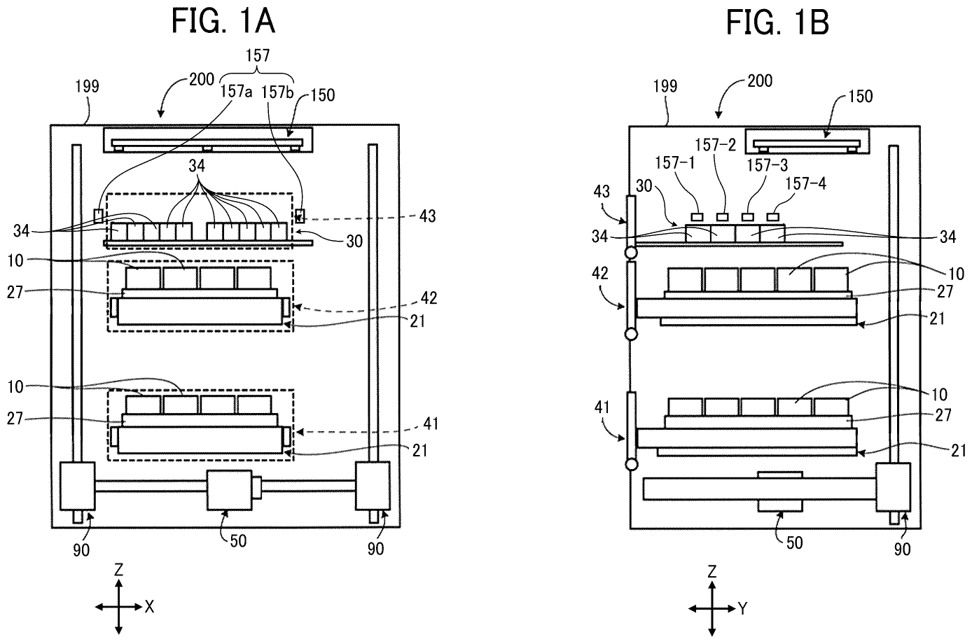

FIG. 1A is a schematic front view of a medication support apparatus in its entirety.

FIG. 1B is a schematic side view of the medication support apparatus 200 of FIG. 1A, according to the present comparative example.

As illustrated in FIG. 1A and FIG. 1B, the medication support apparatus 200 allows manual medicine-dispensing or medicine-sorting operations by, for example, nurse practitioners and care workers who work at a day-care center or nursing home to be switched to automatic medicine-dispensing or medicine-sorting operations by the medication support apparatus 200 itself.

The medication support apparatus 200 is provided with a plurality of cartridges 10 that are an example of medicine-pack housings, medicine dispensing trays 30 that are an example of medicine trays, a pickup device 50, a conveyor 90, and a first gate 41 to a third gate 43. A control board that contains a controller 150 as will be described later in detail is placed at an upper portion of the medication support apparatus 200. The right or left direction or the horizontal direction of the medication support apparatus 200 of FIG. 1A is defined as an X-axis direction, where the right and left directions or the horizontal direction of the medication support apparatus 200 is also referred to as the width direction. The front-rear direction or depth direction of the medication support apparatus 200 of FIG. 1B is defined as a Y-axis direction. The up and down directions or the orthogonal direction of the medication support apparatus 200 of FIG. 1A or FIG. 1B is defined as a Z-axis direction, where the up and down directions or the orthogonal direction of the medication support apparatus 200 is also referred to as the vertical direction.

Each one of the multiple cartridges 10 has a storage space 10a in which a plurality of medicine packages packing several kinds of medicines 3 are stored upon being stacked on top of each other in layers. The medicine package may be referred to simply as a pack or a medicine pack in the following description. The expression “stored upon being stacked on top of each other in layers” in the present disclosure indicates keeping the packs horizontally in such a manner that the front face is viewable.

The multiple cartridges 10 are arranged at the lowermost portion and middle portion of a housing 199 of the medication support apparatus 200 through a cartridge tray 27. In the case of the medication support apparatus 200 as illustrated in FIG. 1A and FIG. 1B, twenty cartridges 10 (4×5=20) are placed and held in a single cartridge tray 27. The cartridge tray 27 serves as a second container in which at least one of the multiple cartridges 10 is placed and held.

Each of the multiple cartridges 10 is placed and housed in a partitioned lattice-like side wall and bottom wall in the cartridge tray 27. On the bottom wall of the cartridge tray 27 corresponding to the cartridges 10, a rectangular through opening through which a pack can be picked up from below one of the multiple cartridges 10, making use of the elasticity or free deformation of the pack as will be described later in detail, is formed. At least, each rectangular through opening on the bottom wall of the cartridge tray 27 has a bottom wall of thickness, size, and shape required to keep the packs inside the storage space 10a when the packs inside the storage space 10a are not to be taken out from a position below the cartridge 10.

Each one of the multiple medicine dispensing trays 30 is an example of a medicine dispensing apparatus that is an example of a medicine tray, a medicine dispenser, or a medicine dispensing table in which the prescribed packs conveyed by the conveyor 90 are arranged. The medicine tray according to the present embodiment is used together with subdivision boxes 34 that serve as individual medicine trays and are detachable from the medicine dispensing tray 30. In the present embodiment described with reference to FIG. 1A and FIG. 1B, two medicine dispensing trays 30 each of which has twenty (=4×5) rooms 33 are arranged. The areas that include the medicine dispensing trays 30 where the packs are passed to the medicine dispensing tray 30 for automatic medicine dispensing are referred to as medicine dispensing areas in the following description.

The pickup device 50 is an example of a pickup device that picks up specific one of the medicine packs from the storage space 10a of the cartridge 10. The conveyor 90 according to the present comparative example serves as a conveyor that conveys the pack picked up from the storage space 10a of one of the multiple cartridges 10 by the pickup device 50.

Each of the first gate 41 and the second gate 42 is an example of an entrance and exit gate for the container, which allows one of the multiple cartridges 10 to enter and exit the housing 199. The multiple cartridges 10 are inserted and set in the housing 199 through each one of the first gate 41 and the second gate 42. The open and close door of one of the first gate 41 and the second gate 42 are opened, and the drawer 21 in which the multiple cartridges 10 are aligned is drawn out to the front side. By so doing, the cartridges 10 are inserted or withdrawn.

The third gate 43 according to the present comparative example serves as an entrance and exit gate for the medicine dispenser, which allows one of the multiple medicine dispensing trays 30 to enter and exit the housing 199. The second gate 42 and the third gate 43 are arranged such that the packs can be taken out immediately after the packs are set or inserted into the medicine dispensing tray 30.

As illustrated in FIG. 1A, the medication support apparatus 200, two medicine dispensing trays 30 are arranged as described above, and as will be described later in detail, the medicine dispensing trays 30 are arranged for each time of medication such as a time in the morning, a time in the daytime, a time in the evening, and a time before going to bed. The third gate 43 for the medicine dispensing tray 30 is also arranged for each one of the medicine dispensing trays 30. Due to such a configuration, another different one of the medicine dispensing trays 30 can be taken out even when the medicine dispensing operation is performed on a particular one of the multiple medicine dispensing trays 30.

The drawers 21 of the multiple cartridges 10 as illustrated in FIG. 1A and FIG. 1B are arranged in two stages on the upper and lower sides under the medicine dispensing trays 30 at the uppermost stage. However, no limitation is intended thereby, and all the drawers 21 may collectively be arranged on an upper side or may collectively be arranged on a lower side. Depending on the number of persons in the day-care center or nursing home, the cartridges 10 may be arranged in three stages to achieve similar advantageous effects.

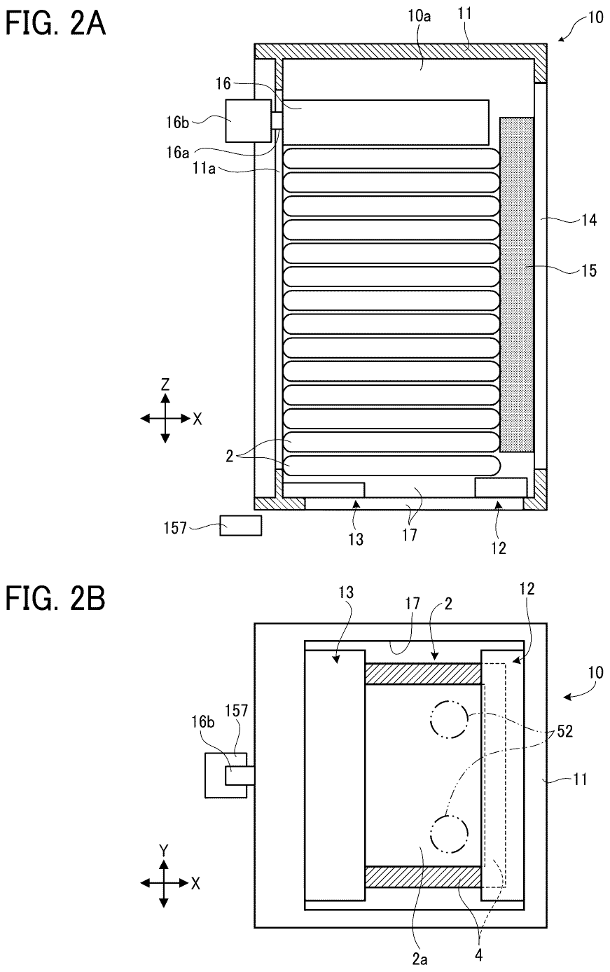

FIG. 2A is a vertical sectional view of the cartridge 10.

FIG. 2B is a bottom view of the cartridge 10 of FIG. 2A.

In order to simplify the drawing, in the vertical section of FIG. 2A, the medicine packs 2 that are stored in the storage space 10a of the cartridge 10 are enlarged schematically to exaggerate for purposes of illustration. In the bottom view of FIG. 2B, a pressure-bonded portion 4 of the medicine pack 2 is illustrated.

For example, each one of the multiple cartridges 10 includes a casing 11, a lid 14, a pack pickup slot 17, a movable board 16, a pack posture keeper 15, and a right support portion 12 and a left support portion 13 each of which serves as a support portion. The casing 11 makes up a container inside of which the storage space 10a is formed, and stores, for example, a plurality of medicine packs 2 or bound packages. In the following description, a single medicine pack 2 will represent such medicine packs 2 or bound packages. For example, the casing 11 is integrally or separately formed using resin. The lid 14 enables the multiple medicine packs 2 to be loaded or unloaded. The pack pickup slot 17 is formed in a lower portion or a bottom portion of the casing 11, and is used to pick up the medicine pack 2 in the storage space 10a of one of the multiple cartridges 10. Moreover, the pack pickup slot 17 allows the medicine pack 2, which is picked up from the storage space 10a by the pickup device 50 (see FIG. 1A and FIG. 1B), to pass therethrough.

The movable board 16 prevents the medicine pack 2 from falling out, and moves the lowermost one of the medicine packs 2 to a position close to the pack pickup slot 17 after the first one of the maximum number of medicine packs 2 that can be stored in the casing 11 is picked up. The pack posture keeper 15 keeps the posture of the medicine pack 2. The right support portion 12 and the left support portion 13 also support or hold the medicine pack 2 in the casing 11.

In the present embodiment, the to-be-picked-up portion of one of the multiple medicine packages 2 to be picked up from the storage space 10a of one of the multiple cartridges 10 by the pickup device 50 is at a lower portion or bottom portion of the storage space 10a of the corresponding one of the multiple cartridges 10. In other words, the to-be-picked-up portion includes the pack pickup slot 17, and the right support portion 12 and the left support portion 13 that serve as a pair of support portions or supporting member and support, at a plurality of points, one of the multiple medicine packs 2 to be picked up from the storage space 10a of one of the multiple cartridges 10.

When one of the multiple medicine packs 2 is picked up from the storage space 10a of one of the multiple cartridges 10 by the pickup device 50, the right support portion 12 and the left support portion 13 allow one of the multiple medicine packs 2 to pass through. On the other hand, when any one of the multiple medicine packs 2 is not to be picked up from the storage space 10a of one of the multiple cartridges 10, the multiple medicine packs 2 are to be stored and held in the casing 11. In order to achieve that, the right support portion 12 and the left support portion 13 are configured to restrict the passage of one of the multiple medicine packs 2.

As described above, the right support portion 12 and the left support portion 13 serve as a pair of support portions that support or hold the multiple medicine packs 2 in the storage space 10a of the one of the multiple cartridges 10, and each one of the right support portion 12 and the left support portion 13 is fixed and immovable such that one of the multiple medicine packs 2 can be picked up in a stable manner from the storage space 10a of one of the multiple cartridges 10 by the pickup device 50. The right support portion 12 and the left support portion 13 are a pair of fixation members that are fixed or attached to the pair of bottom-wall inner surfaces of the right bottom-wall edge and left bottom-wall edge of the pack pickup slot 17, respectively. The pack pickup slot 17 has both a function to allow the pair of suction pads 52 of the pickup device 50 illustrated in FIG. 2B, which serves as an air suction unit or a suction unit, to pass therethrough in order to pick up one of the multiple medicine packs 2 and a function to allow the picked-up medicine pack 2 and the pair of suction pads 52 to pass therethrough.

In one of the multiple cartridges 10 illustrated in FIG. 2B, a pair of positions at which the pair of suction pads 52 adsorb or suck up one of the multiple medicine packs 2 stored in the storage space 10a of one of the multiple cartridges 10, are indicated by a pair of ring-shaped dot-dot-dash lines. Such a pair of positions may be referred to as a pair of suction-pad positions in the following description. The right support portion 12 and the left support portion 13 that are arranged underneath the storage space 10a of one of the multiple cartridges 10 support the multiple medicine packs 2 in the storage space 10a of one of the multiple cartridges 10 such that the multiple medicine packs 2 in one of the multiple cartridges 10 do not fall from the pack pickup slot 17. As will be described later in detail in regard to the operation of the pickup device 50, when the medicine pack 2 at the bottom of the storage space 10a inside the cartridge 10 is sucked and picked up by the pair of suction pads 52, one of the multiple medicine packs 2 is sucked by the pair of suction pads 52 at two suction-pad positions in the Y-axis direction near both ends of the right support portion 12. When the lowermost one of the multiple medicine packs 2 is picked up from the storage space 10a of one of the multiple cartridges 10 by the pair of suction pads 52, the pair of suction pads 52 passe near both ends of the right support portion 12 in the Y-axis direction to suck and hold one of the multiple medicine packs 2.

As illustrated in FIG. 2B, two points at which the pair of suction pads 52 contact the medicine package are arranged near both ends of the right support portion 12 in the Y-axis direction. Due to such a configuration, the possibility of an error in which the suction by the pair of suction pads 52 is disabled can be avoided and prevented, and the picking up operation can be done successfully. In other words, the medicine pack 2 is sucked and adhered to the pair of suction pads 52 at both ends in the Y-axis direction, and a bag 2a of the medicine pack 2, which is made of film, is stretched and can withstand the deformation. Accordingly, both reliable support or holding of the multiple medicine packs 2 in the storage space 10a of one of the multiple cartridges 10 and smooth removal of one of the multiple medicine packs 2 can be achieved.

The pack posture keeper 15 is formed of sponge rubber having appropriate elasticity. The movable board 16 as well as the shaft 16a and the feeler 16b are made of, for example, resin or metal. The pack posture keeper 15 and the movable board 16 hold the posture of the multiple medicine packs 2 under normal operating conditions in the casing 11. As explicitly illustrated in FIG. 2A, the posture of the multiple medicine packs 2 is held orderly in the Z-axis direction in a substantially horizontal state. In order to achieve the above-described function, the movable board 16 is arranged to move at least one of the multiple medicine packs 2 left in the casing 11 toward the pack pickup slot 17 as moving downward in the casing 11 in the Z-axis direction by its own weight.

As illustrated in FIG. 2A, a long groove 11a that extends in the Z-axis direction with a predetermined width in the X-axis direction is formed in the side wall of the casing 11. The shaft 16a with the feeler 16b, which is an example of a displacement unit, is placed at one end of the movable board 16 so as to protrude from the long groove 11a. As the shaft 16a of the movable board 16 with the feeler 16b is guided in the Z-axis direction parallel to the long groove 11a, the posture of the multiple medicine packs 2 can be held in the Z-axis direction. In FIG. 2A, the multiple medicine packs 2 in the storage space 10a of one of the multiple cartridges 10 are stacked on top of each other in layers in a substantially horizontal state. However, in actuality, left portions of the medicine packs 2 in FIG. 2A filled with the medicines 3 are expanding.

A set of the multiple medicine packs 2 are orderly stored in the casing 11 toward the upper side from the pack pickup slot 17 on the right support portion 12 and the left support portion 13. The timing at which the multiple medicine packs 2 are supplied into the storage space 10a of one of the multiple cartridges 10 may be, for example, the timing at which a patient who takes medicines or occupant is examined in a day-care center or nursing home, which is typically once a two weeks, or the timing at which the multiple medicine packs 2 in the storage space 10a of one of the multiple cartridges 10 run out. When some medicine packs 2 are left in the storage space 10a of one of the multiple cartridges 10 at the time of replenishment, such replenishment is continued from the back of the remaining medicine packs 2. Under normal operating conditions, the above-described setting of the multiple medicine packs 2 into the storage space 10a of one of the multiple cartridges 10 and the replenishment of the multiple medicine packs 2 are done by a staff or the like in a day-care center or nursing home. However, no limitation is indicated thereby. In particular, in configurations where cartridges are used instead of containers and the setting or replenishment of the medicine packs 2 are done automatically, the setting or replenishment of the medicine packs 2 may be done differently.

The lid 14 is used by a staff or the like who works at a day-care center or nursing home to enable loading or unloading of the multiple medicine packs 2 stored in the storage space 10a of one of the multiple cartridges 10, and as illustrated in FIG. 2A, is formed with a wide length in the Z-axis direction of the casing 11 and has a predetermined opening width.

As illustrated in FIG. 2A, the types of the multiple medicine packs 2 in the storage space 10a of one of the multiple cartridges 10 are sorted or divided based on the timings at which medicines are taken. For example, one cartridge contains medicines to be taken in fourteen days in the morning by Mr. or Ms. A. In view of the above circumstances, if Mr. or Ms. A takes the medicines not only in the morning but also in the daytime or in the evening, or before going to bed, four cartridges 10 are required in total. However, no limitation is indicated thereby. For example, in an alternative embodiment of the present disclosure, a single cartridge 10 may be prepared for each person or patient who takes medicines. In such cases, for example, a pack to be used in the morning on day one, a pack to be used at lunchtime on day one, a pack to be used in the evening on day one, a pack to be used before going to bed on day one, a pack to be used in the morning on day two, a pack to be used at lunchtime on day two, and a pack to be used in the evening on day two may be stored in the order listed upward from the pack pickup slot 17 parallel to the direction in which packs are taken out from the multiple cartridges 10.

In the present embodiment, the right support portion 12 and the left support portion 13 are fixed to the bottom-wall inner surface of the pack pickup slot 17 of the casing 11 such that one of the multiple medicine packs 2 can be picked up in a steadily stable manner from the storage space 10a of one of the multiple cartridges 10 by the pickup device 50. In other words, the right support portion 12 and the left support portion 13 are fixed when the right support portion 12 and the left support portion 13 hold both ends of the medicine pack such as the medicine pack 2 or the bound packages around the pack pickup slot 17 arranged at the lower portion of one of the multiple cartridges 10.

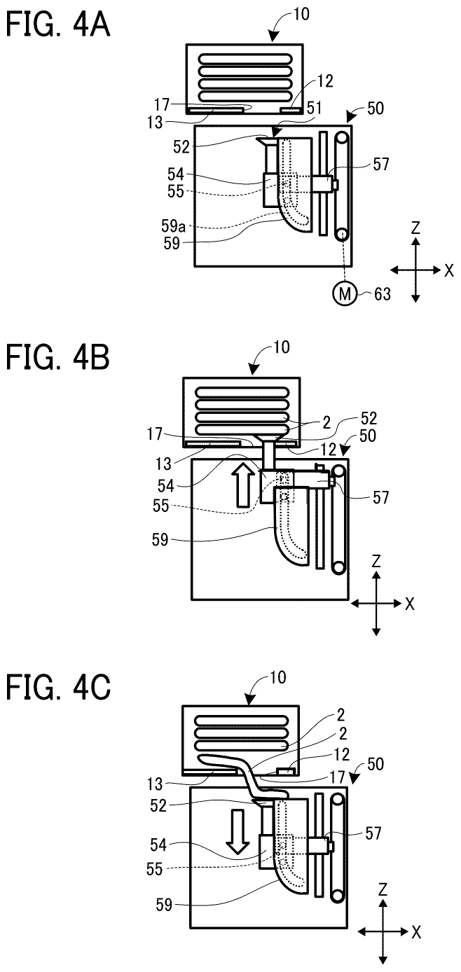

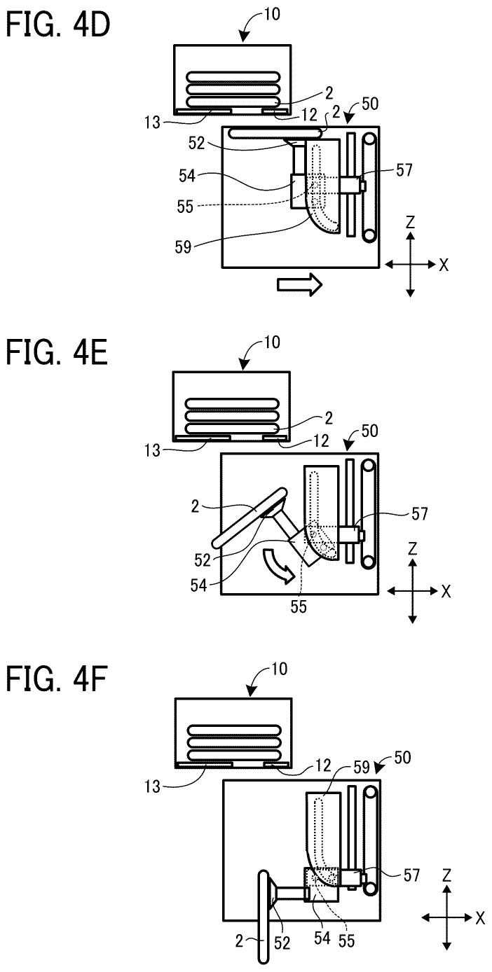

The medicine pack 2 that is stored in the storage space 10a of the cartridge 10 is supported by a right support portion 12 and a left support portion 13 so as not to drop. The right support portion 12 supports a right end where the medicine pack 2 is sucked up, and the left support portion 13 supports a left end on the other side. The right support portion 12 and the left support portion 13 are different in the length of the portion that supports the multiple medicine packs 2, and the length of the portion of the right support portion 12 that supports the multiple medicine packs 2 is shorter than that of the left support portion 13. As will be described later in detail with reference to FIG. 4C, when the lowermost one of the multiple medicine packs 2 stored in the storage space 10a of the cartridge 10 is adsorbed or sucked by the pair of suction pads 52 and is pulled out from the storage space 10a of the cartridge 10, the medicine pack is bent due to its elasticity. Accordingly, the medicine pack can easily be pulled out.

In the above configuration, the pair of support portions including the right support portion 12 and the left support portion 13 are of fixed type. Accordingly, the front end of the next one of the multiple medicine packs 2 to be taken out can be reliably held and does not jump out or fall off together with one of the multiple medicine packs 2 that is being taken out. As the pair of support portions including the right support portion 12 and the left support portion 13 do not swing or rotate, the medicine pack 2 are held with high stability with no deformation or the like due to unintentional nipping or pressing in the returning operation.

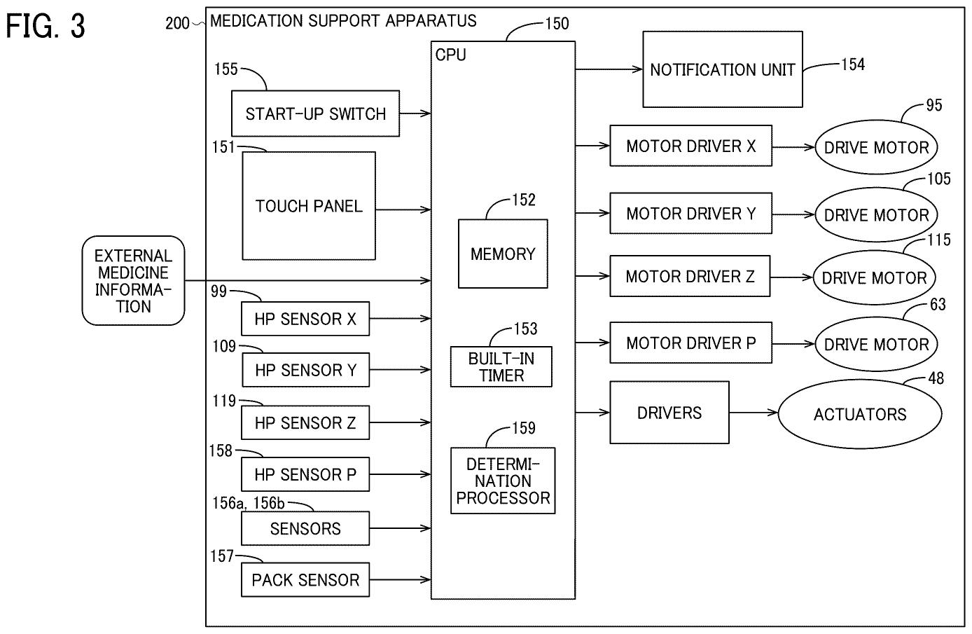

FIG. 3 is a diagram illustrating the control blocks of a medication support apparatus.

As illustrated in FIG. 3, the medication support apparatus 200 includes a central processing unit (CPU) that serves as a controller 150 that controls the operation of, for example, the components or elements of the medication support apparatus 200. For example, the CPU is provided with a built-in memory 152 or a built-in timer 153, and serves as a determination processor 159. The CPU according to the present embodiment may provide notification to, for example, a user including staff or the like at a timing consistent with the program or may instruct the medication support apparatus 200 to perform a particular operation, based on various kinds of input such as the inputs from a sensor as will be described later in detail. To the built-in memory 152, prescription data or medicine information is externally input as external medicine information.

The CPU may have, for example, a computing or control function, and a timer or clocking function. The built-in memory 152 includes, for example, a read-only memory (ROM), a random-access memory (RAM), and an external memory. The ROM according to the present embodiment stores, for example, a program readable by the above CPU and various kinds of data in advance. Such a program stored in the ROM may be a program used in the flowchart of the controlling processes as will be described later in detail. The above various kinds of data may be, for example, the data about the relation between the medicine packs 2 and the rooms 33 or the subdivision boxes 34 of one of the medicine dispensing trays 30 allocated to each of the patients who take medicines, the data about the relation between the medicine packs 2 and the multiple rooms 33 or the multiple subdivision boxes 34 of one of the medicine dispensing trays 30 assigned to each one of the times of medication, or the data about the relation between the medicine packs 2 and the rooms 33 or the subdivision boxes 34 of one of the medicine dispensing trays 30 sorted according to the order in which medicines are to be taken.

The CPU has an input and output (I/O) port, and a touch panel 151 that is an example of a user interface (UI) provided with an input unit and a display unit is electrically connected to that input and output port of the CPU. Through the touch panel 151, various kinds of inputs can be made, and for example, the current time, the progress of the storing process of packs, or the stop time are displayed on the touch panel 151. How such inputs are made or the structure or configuration of such a display unit are not limited thereto, and may be, for example, an input unit and a display unit may be arranged separately. Alternatively, a combination of an input device and a display interface such as a combination of a keyboard and a light-emitting diode (LED) display may be adopted.

To the input port of the CPU, a start-up switch 155 that drives the medication support apparatus 200 to operate is electrically connected. Once the start-up switch 155 is touched or pressed down, the medicine dispensing operation to the medicine dispensing trays 30 starts step by step. The medicine dispensing operation to the medicine dispensing trays 30 may start at a time determined in advance by the built-in timer 153.

The CPU according to the present embodiment has an input port, various types of sensors such as a medicine dispensing tray sensor 156a that detects the type of the medicine dispensing tray 30 stored in the medication support apparatus 200 or determines whether or not there is any medicine dispensing tray 30, a container sensor 156b that determines whether or not there is any cartridge 10, and a pack sensor 157 that is arranged at one of the medicine dispensing areas and is an example of a sensor are electrically connected to the input port of the CPU. The medicine dispensing tray sensor 156a and the container sensor 156b are illustrated in FIG. 3.

To the input port of the above CPU, a home position (HP) sensor 99 that is used for a home position (HP) sensor X to detect the home position (HP) of the X-axis direction conveyor 91 in the pickup device 50, an HP sensor 109 that is used for an HP sensor Y to detect the home position (HP) of the Y-axis direction conveyor 101 in the pickup device 50, and an HP sensor 119 that is used for an HP sensor Z to detect the home position (HP) of the Z-axis direction conveyor 111 in the pickup device 50 are electrically connected.

Further, to the input port of the CPU, a home position (HP) sensor 158 for an HP sensor P that detects the home position (HP) of the pair of suction pads 52 of the suction device 51 in the pickup device 50 is electrically connected.

To the output port of the above CPU, the drive motor 95 for the X-axis direction conveyor, the drive motor 105 for the Y-axis direction conveyor, the drive motor 115 for the Z-axis direction conveyor, and the drive motor 63 used to change the posture or attitude of the pair of suction pads 52 are electrically connected to the input port of the CPU through various kinds of motor drivers X, Y, Z, and P, respectively.

To the output port of the CPU, a suction pump 48 that serves as various kinds of actuator is electrically connected through various kinds of drivers. To the output port of the CPU, a notification unit 154 may be electrically connected. Such a notification unit 154 reports what sort of state or conditions the components or elements of the medication support apparatus 200 are in by means of, for example, the light emitted from a light-emitting diode (LED) and the sound or vibration including voice. Moreover, the notification unit 154 may be provided with, for example, a loudspeaker or a light that indicates that the medicines are to be taken so that the staff or the like away from the medication support apparatus 200 can be notified of such a time of medication.

The external medicine information is also input to the CPU through an input and output (I/O) interface, and is stored in the built-in memory 152. For example, the external medicine information is used for the allocation of medicines to patients who take medicines. For example, the LEDs of the drawer 21 may be electrically connected to each other.

Once the input data from the touch panel 151 and various kinds of signals from various types of sensors or the HP sensors 99, 109, 119, and 158 are input to the CPU, a command signal is newly output from the CPU. In other words, the CPU according to the present embodiment outputs a command signal used to control the audio device or the optical device of the display device of the touch panel 151 including the above notification unit 154, the LEDs, the suction pump 48, the drive motor 63, the drive motor 95, the drive motor 105, the drive motor 115, or the multiple drives that correspond to the multiple LEDs.

The HP sensor 158 for the HP sensor P and the drive motor 63 that outputs power through the motor driver P are used to control or drive the mechanism for moving the suction device to move upward and downward. The CPU according to the present embodiment has a function to execute the control operation as will be described later in detail in the following description or the flowchart of the controlling processes.

For example, it is desired that the drive motor 63, the drive motor 95, the drive motor 105, and the drive motor 115 be a stepper motor driven by pulse input because of its precise amounts of movement and its control with a high degree of precision.

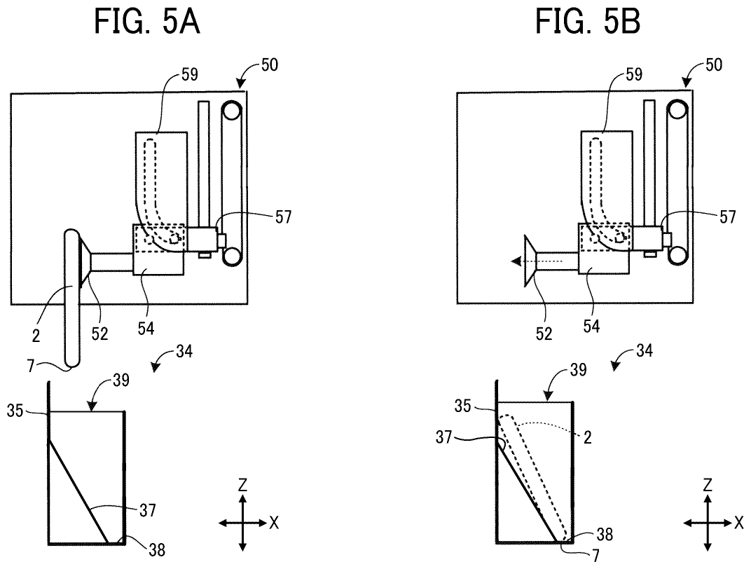

FIG. 4A to FIG. 5B are front views of a pickup device, illustrating the progression of the operation of the pickup device.

For the sake of explanatory convenience, it is assumed in the present embodiment that, due to the operation of the conveyor 90 illustrated in FIG. 1A and FIG. 1B, the pickup device 50 is placed below the cartridge 10 provided for one of the drawers 21 arranged at the central portion of the housing 199 illustrated in FIG. 1A and FIG. 1B. After the pair of suction pads 52 of the pickup device 50 sucks and pulls out the lowermost pack in the storage space 10a of the cartridge 10, as the conveyor 90 operates, the pickup device 50 moves above the medicine dispensing tray 30, which is placed uppermost in FIG. 1A and FIG. 1B. Then, the pickup device 50 automatically drops and inserts the pack into the subdivision box 34 attached to a specific partition of the medicine dispensing tray 30. In FIG. 4A to FIG. 5B, the cartridges illustrated in FIG. 2A and FIG. 2B are used as the cartridges 10.

As illustrated in FIG. 4A, the pickup device 50 is moved under one of the multiple cartridges 10 by the operation made by the conveyor 90 illustrated in FIG. 1A and FIG. 1B, and stops moving. Under such conditions, the drive motor 63 of the suction-device lifting and lowering unit is stopped, and the pair of suction pads 52 are positioned under the position of the top face of the pickup device, which indicates the position of the top face of the picking-up frame of the pickup device 50 in a housing.

Subsequently, as described with reference to FIG. 4B, the drive motor 63 is driven to rotate, and firstly, the suction device base 57 and the pair of suction pads 52 move upward in a straight line through the coupling between the suction device base 57 that linearly moves and the suction-pad supporting member 54 that linearly and rotationally moves. Accordingly, the pair of suction pads 52 enter from the pack pickup slot 17 between the right support portion 12 and the left support portion 13, and as soon as the pair of suction pads 52 contact one of the multiple medicine packs 2 at the bottom of the storage space 10a of one of the multiple cartridges 10, the pair of suction pads 52 suck that medicine pack 2. In so doing, the suction pump 48 as described above is driven to operate in advance so that the suctioning operation can be performed.

Subsequently, as illustrated in FIG. 4C, as the drive motor 63 is reversely operated, the pair of suction pads 52 move downward while sucking one of the multiple medicine packs 2 by the pair of suction pads 52, and the front end of one of the multiple medicine packs 2 is pulled out from the storage space 10a of one of the multiple cartridges 10. The front end of the medicine package indicates a side of the medicine package to be absorbed or sucked up by the pair of suction pads 52, and the same applies in the following description. The operation of pulling out the front end of one of the multiple medicine packs 2 from the pack pickup slot 17 of one of the multiple cartridges 10 results in sort of free deformation in the pulled-out medicine pack 2.

Subsequently, as illustrated in FIG. 4D, by the operation of the conveyor 90 (see FIG. 1A and FIG. 1B), the pickup device 50 is moved in the X-axis direction, which is the lateral direction, and the rear end of one of the medicine packs 2 is drawn out or picked up from the storage space 10a of one of the multiple cartridges 10. Immediately after that, as illustrated in FIG. 4E and FIG. 4F, by the operation of the drive motor 63, one of the multiple medicine packs 2, which is approximately in a horizontal state and is sucked and held by the pair of suction pads 52, is rotated by substantially 90 degrees to change the posture to an approximately vertical or upright posture. In such a rotational operation, the rotary shaft 55 that is placed on the suction-pad supporting member 54 moves along the guide groove 59a of the guide 59. Accordingly, the posture of one of the multiple medicine packs 2 can be changed from an approximately horizontal posture to an approximately vertical posture. The above series of operations in the above configuration may be achieved by a series of operations performed by a single drive motor 63.

Subsequently, as illustrated in FIG. 5A, the pickup device 50 that includes the pair of suction pads 52 and vertically holds one of the multiple medicine packs 2 is carried to the medicine dispensing area substantially directly above the medicine dispensing trays 30 by the conveyor 90, and the operation of the suction pump 48 is terminated. As illustrated in FIG. 5B, when the suction holding of one of the multiple medicine packs 2 by the pair of suction pads 52 is to be released, so-called vacuum breakdown in which negative pressure is changed to atmospheric pressure is performed by ejecting a small amount of air using the above suction pump 48 that serves as an air supply unit or compressor. As a result, the suction holding of one of the multiple medicine packs 2 by the pair of suction pads 52 is released, and the medicine package 2, which is indicated by a broken line, is inserted into the subdivision box 34 through an insertion slot 39 that is an example of the opening of desired one of the subdivision boxes 34 in one of the rooms 33 of the medicine dispensing tray 30.

Subsequently, a bottom end 7 of the inserted medicine pack 2 contacts the inclined portion 37 inside the subdivision box 34, and simply slides down along the inclined portion 37. In so doing, the medicine pack 2 is stored further inside the subdivision box 34 while the top end of the medicine pack 2 is being tilted backward along a rear side 35. As illustrated in FIG. 5B, the medicine pack 2 stops moving when the bottom end 7 of the inserted medicine pack 2 contacts a bottom side 38 of the subdivision box 34, and completely enters the subdivision box 34. Accordingly, a surface of the medicine pack 2 that is placed inside the subdivision box 34 is oriented upward, and medication-related information can be checked as desired.

As described above, in the present embodiment, when desired one of the multiple medicine packs 2 is picked up from one of the multiple cartridges 10, the pickup device 50 is positioned or arranged under one of the multiple cartridges 10, and such desired one of the multiple medicine packs 2 is taken out in the downward direction of the storage space 10a of one of the multiple cartridges 10. When one of the multiple medicine packs 2 is taken out from the lower side of one of the multiple cartridges 10 as described above, the next one of the multiple medicine packs 2 automatically moves downward or toward the pack pickup slot 17 due to the self weight of the movable board 16 and the multiple medicine packs 2 left in the storage space 10a of the cartridge 10. Due to such a configuration, the pickup device 50 can perform the same operation with a relatively simple configuration regardless of the number of the multiple medicine packs 2 left in the storage space 10a of the cartridge 10.

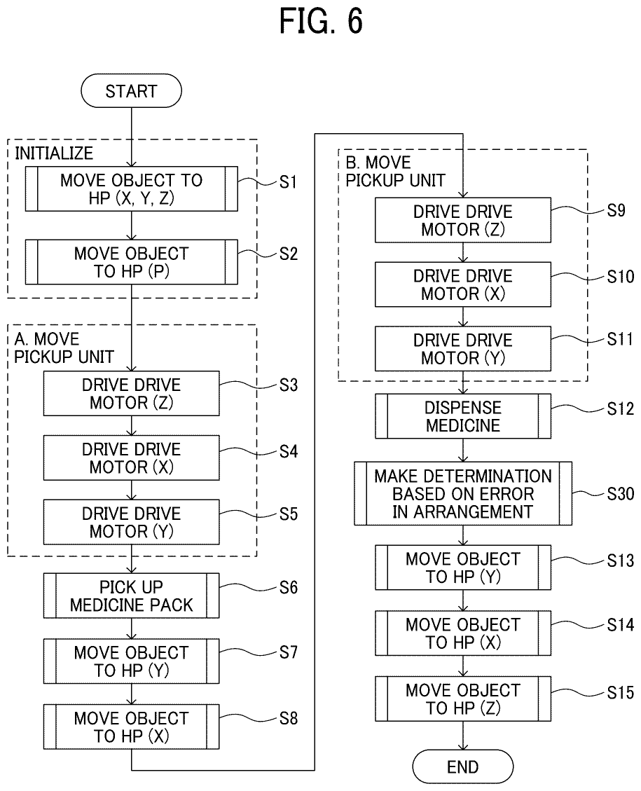

FIG. 6 is a flowchart of the sequence of basic operation of the medication support apparatus 200.

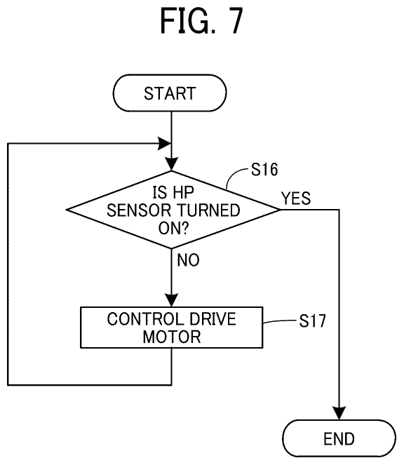

FIG. 7 is a flowchart of the processes of moving the home position (HP), which is a subroutine program of FIG. 6.

The operations in FIG. 6 and FIG. 7 are executed under the control commands from the CPU of the controller 150. When the start-up switch 155 illustrated in FIG. 3 is turned on, the process starts, and in steps S1 and S2, firstly, initialization is performed as illustrated in FIG. 6 (see the initialization part indicated by a frame of broken line in FIG. 6).

In the initialization, the HP sensor and the corresponding drive motor are controlled by the subroutines as depicted in FIG. 7, and an object to be controlled is moved to a predetermined home position (HP) where the HP sensor is turned on (see steps S16 to S17 in FIG. 7). A series of processes are automatically performed by a built-in timer 153 as depicted in FIG. 3 as follows at prescribed timings that correspond to the medication support operations in the morning, at lunchtime, in the evening, or before going to bed, based on the medicine information that is externally obtained in advance or the input from the touch panel 151 illustrated in FIG. 3.

At predetermined times, in steps S3 to S5, the CPU drives the drive motor 115, the drive motor 95, and the drive motor 105 that correspond to Z, X, and Y, respectively, in the order listed to move the pickup device 50 to desired one of the cartridges 10 (see “A. MOVE PICKUP DEVICE” indicated by a frame of broken line in FIG. 6). Subsequently, as a series of picking-up operations, a drive motor 63 that is used for a drive motor P is driven so that the pair of suction pads 52 are moved close to the medicine pack 2 (see FIG. 4B), and the vacuum ejector valve is controlled to make the pair of suction pads 52 suck the medicine package 2. Subsequently, the drive motor 63 and a drive motor 95 that is used for a drive motor X are operated in cooperation with each other to pick up one of the medicine packs 2 from a position below one of the multiple cartridges 10 (see FIG. 4C and FIG. 4D). Then, in steps S6 to S8, the posture of the pair of suction pads 52 are rotated, and the medicine pack 2 is vertically held (see FIG. 4E and FIG. 4F).

Subsequently, in steps S9 to S11, the CPU drives the drive motor 115, the drive motor 95, and the drive motor 105 that correspond to Z, X, and Y, respectively, in the order listed to move the pickup device 50 so as to move of the medicine pack 2 to a position above desired one of the rooms 33 of one of the medicine dispensing trays 30 (see “B. MOVE PICKUP DEVICE” indicated by a frame of broken line in FIG. 6). Then, in step S12, a medicine dispensing operation is performed. In the medicine dispensing operation, after the operation of the pickup device 50 is terminated, the vacuum ejector valve is controlled to cause vacuum breakdown. As a result, suctioning is released to separate one of the medicine packs 2 and dispense the separated medicine package to the medicine dispensing tray 30 (see FIG. 5A and FIG. 5B). These operations are performed several times. When the delivery of the medicine packs for a predetermined number of persons is completed, as will be described later in detail, positioning error determination processes (S30) are performed in the present embodiment. When such positioning error determination processes (S30) are successfully completed, the loudspeaker or the light of the notification unit 154 is instructed to notify a medication assistant that the preparation is complete (see steps S12 to S15).

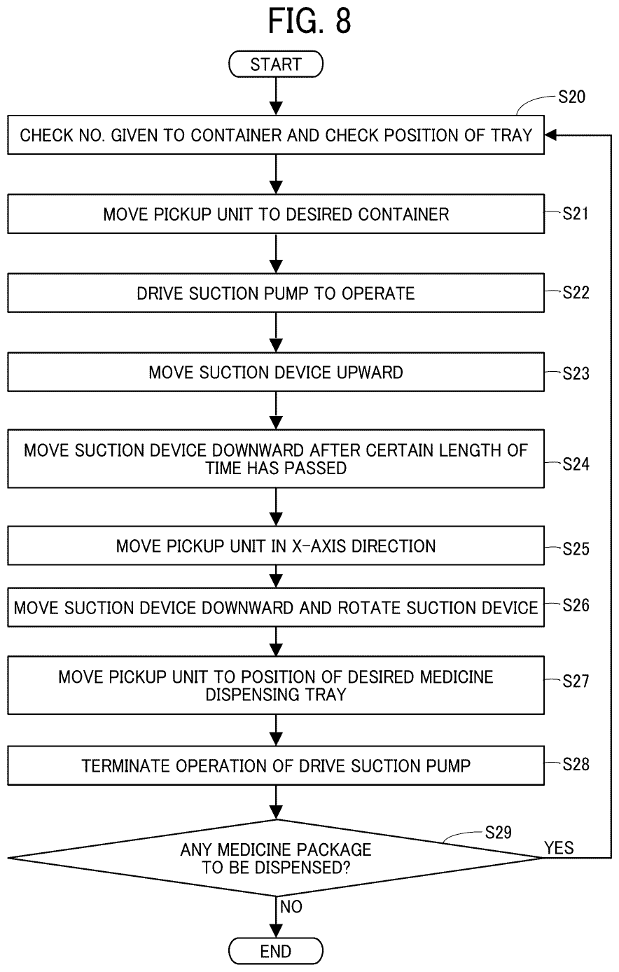

A supplemental description of the operation of the pickup device 50 in the basic operation described above with reference to FIG. 6 and FIG. 7 is given below with reference to FIG. 8.

FIG. 8 is a supplemental flowchart of the operation of a pickup device.

Firstly, in step S20 of FIG. 8, the number (No.) given to desired one of the multiple cartridges 10 that stores the medicine pack 2 to be dispersed is checked, and a desired position of the medicine dispensing tray 30 to which the medicine pack 2 is passed is specified in advance. In other words, the number (No.) given to desired one of the cartridges 10 and the position number of the medicine dispensing tray 30 are specified in advance by the touch panel 151 illustrated in FIG. 3. Subsequently, in step S11, the pickup device 50 is moved to desired one of the multiple cartridges 10 by the conveyance operation of the conveyor 90.

Subsequently, the drive motor 63 is driven to rotate while the suction pump 48 is being driven. As a result, in step S22 and step S23, the suction device 51 moves upward. After a certain length of time has passed after the lowermost one of the multiple medicine packs 2 in the storage space 10a of one of one of the multiple cartridges 10 is sucked and held by the pair of suction pads 52, the drive motor 63 is driven to rotate in the reverse direction. Accordingly, in step S24, the suction device 51 moves downward. Subsequently, in step S25, the pickup device 50 is moved in the X-axis direction, and desired one of the multiple medicine packs 2 is completely taken out from one of the multiple cartridges 10. Then, in step S26, the drive motor 63 is further driven to rotate in the reverse direction so as to move the suction device 51 downward. As a result, the suction device 51 is rotated by approximately 90 degrees, and the posture of the medicine pack 2 is changed from an approximately parallel or horizontal posture to an approximately vertical posture.

Subsequently, the pickup device 50 is moved to a desired position of one of the multiple medicine dispensing trays 30 by the conveyor 90. In step S27, the pickup device 50 has moved to the position of desired one of the multiple medicine dispensing trays 30, and then in step S28, the operation of the suction pump 48 is terminated. As a result, the medicine pack 2 is released and separated from the pair of suction pads 52. In so doing, the medicine pack 2 is inserted into the subdivision box 34, which is attached to desired one of the rooms 33 of the medicine dispensing tray 30, through the insertion slot 39.

Subsequently, the bottom end 7 of the inserted medicine pack 2 contacts the inclined portion 37, and simply slides down along the inclined portion 37. In so doing, the medicine pack 2 is stored further inside the subdivision box 34 while the top end of the medicine pack 2 is being tilted backward along a rear side 35. As illustrated in FIG. 5B, the medicine pack 2 stops moving when the bottom end 7 of the inserted medicine pack 2 contacts a bottom side 38 of the subdivision box 34, and completely enters the subdivision box 34.

Then, in step S29, whether there is any medicine pack 2 to be dispensed is checked. When there is no medicine pack 2 to be dispersed, a series of operations is terminated. On the other hand, when it is determined in the step S29 that there is at least one medicine pack 2 to be dispensed, the process is returned to the step S20, and the same series of processes in the above steps are repeated.

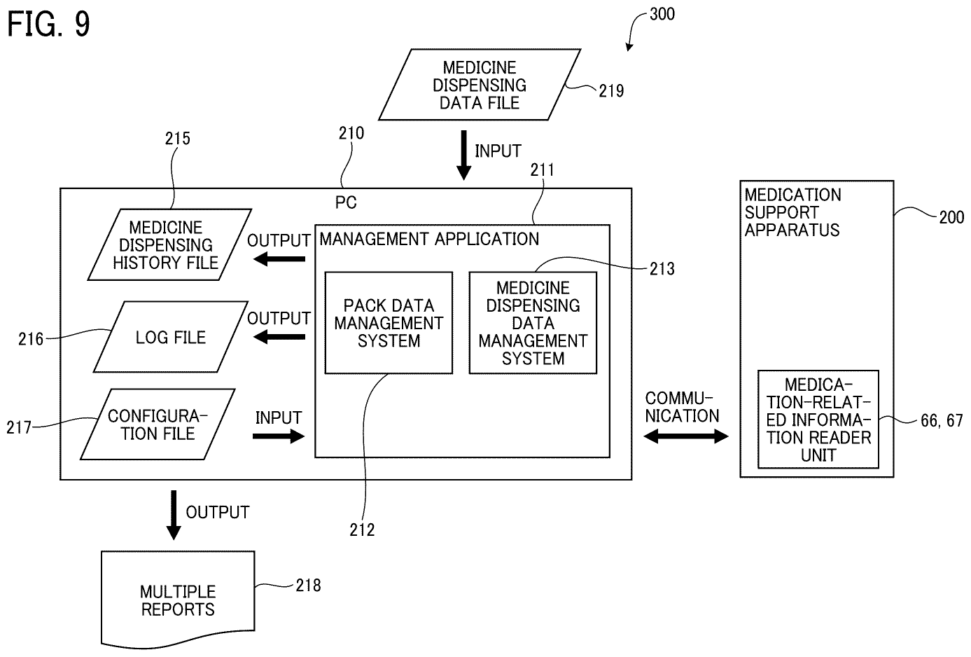

FIG. 9 is a diagram illustrating the control blocks of a medication support system.

As illustrated in FIG. 9, the medication support system 300 is provided with the above-described medication support apparatus 200 and a personal computer (PC) 210 coupled to the medication support apparatus 200. Such coupling enables communication such as data transmission and data reception.

The PC 210 includes five elements known in the art. In other words, the PC 210 is provided with, for example, a control device, a processor, an input device, and an output device. The above control device of the PC 210 is provided with a central processing unit (CPU), and executes a program or gives instructions to other devices. The above processor of the PC 210 executes a program or performs computation. The above memory of the PC 210 is provided with, for example, a main memory and an auxiliary memory, and stores data such as programs or texts. The above input device of the PC 210 includes, for example, a mouse, a keyboard, a microphone, and sends data or instructions to the computer. The above output device of the PC 210 includes, for example, a display, a printer, a loudspeaker, and outputs the data output from the computer.

The PC 210 fulfills the function of the medication support apparatus 200, and serves as a host computer that manages and supports the medication support apparatus 200. The PC 210 is connected to a terminal in a pharmacy or the like at which the medicine is supplied, through the network.

The pack data management system 212 provided for the management application 211 manages the medication-related information of the medicine pack. The medicine-dispensing data management system 213 provided for the management application 211 reads and manages the medicine dispensing data including at least the name of a patient who takes medicines and the times of medication.

For example, the pack data management system 212 and the medicine dispensing data management system 213 may be implemented as the management application 211 in the PC 210. As illustrated in FIG. 9, a system may include the medication support apparatus 200 and the PC 210 and performs management by communicating with the medication support apparatus 200. The management application 211 reads the medicine-dispensing data file 219 that is externally produced at a pharmacy or the like where medicines are supplied based on the prescription given by a doctor and includes, for example, times at which medicines are dispensed and medicine information for each patient who takes medicines. The management application 211 reads the data output from the configuration file 217 in which, for example, the setting information once applied to the PC 210 is recorded.

For example, a file to be output as log file 216 according to what has been changed or a medicine dispensing history file 215 in which medicine dispensing history is tracked is the data to be output from the management application 211 as necessary. Further, the multiple reports 218 are output as necessary from the PC 210 through the management application 211. The functions such as of the management application 211 of the PC 210 may be arranged in the medication support apparatus 200.

In the medicine-dispensing data management system 213, the results of medicine dispensing or the change history are stored as a record. By so doing, the actual medicine dispensing results are stored as traceability information. This enables a review when a problem occurs.

The pack data management system 212 performs management based on the medication-related information of the medicine pack including at least the name of a patient who takes medicines and the times of medication. However, no limitation is indicated thereby, and a supplementary explanation of the operation of, for example, the medication support apparatus 200 described above is given below.

The pickup device 50 that is an example of a carriage is provided with an upper quick response (QR) code reader 66 and a lower QR code reader 67 in the medication support apparatus 200. The pickup device 50 moves close to one of the multiple cartridges 10 that stores a medicine pack such as a medicine package and bound medicine packages, and the QR CODE that indicates the medication-related information can be read by the upper reader unit of the upper QR code reader 66.

A configuration of a sensor in the medication support apparatus 200 that detects whether the medicine pack 2 conveyed by the conveyor 90 is appropriately placed in one of the subdivision boxes 34 of the medicine dispensing tray 30 is described below.

FIG. 10 is a schematic perspective view of the pack sensor 157 that is an example of a sensor.

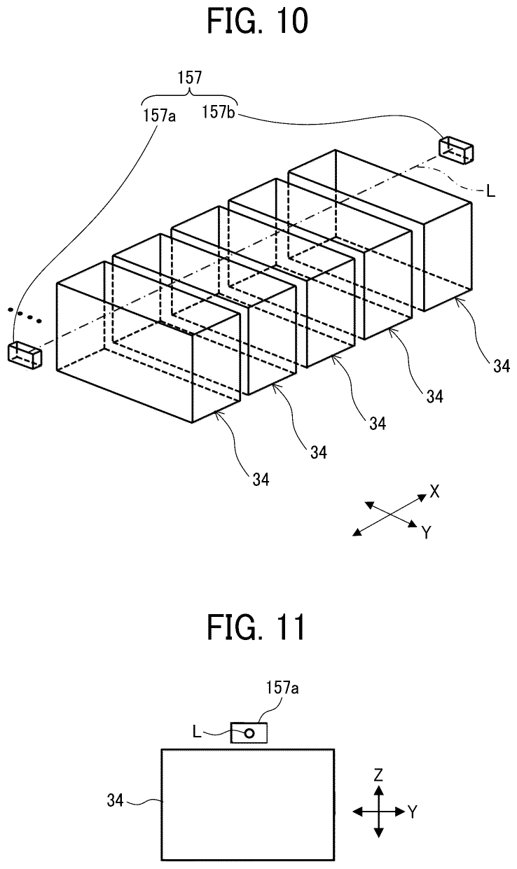

FIG. 11 is a diagram illustrating the phototransmitter 157a of the pack sensor 157 viewed in its optical-axis direction.

The pack sensor 157 detects whether the medicine pack 2 is in an upper space of the insertion slot 39 of the subdivision box 34, which is an upstream area in the insertion direction of the medicine packs. The pack sensor 157 of such a configuration can be configured or formed easily at low cost, using, for example, an optical sensor whose detection field is an upper space of the insertion slot 39 of the subdivision box 34.

The pack sensor 157 is a transmissive optical sensor including a phototransmitter 157a that is an example of a light emitter to emit a detection light L and a light receiver 157b to receive the detection light L that has passed through the detection field. The phototransmitter 157a emits the detection light L in the horizontal direction, which is a direction orthogonal to the insertion direction of the medicine packs, toward the detection field, i.e., an upper space of the insertion slot 39 of the subdivision box 34. The pack sensor 157 is arranged at a height where the medicine pack 2 that is inserted through the insertion slot 39 of the subdivision box 34 and appropriately placed inside the subdivision box 34 does not block the detection light L and a portion of the medicine pack 2 that protrudes from the insertion slot 39 of the subdivision box 34 blocks the detection light L.

The degree of protrusion from the insertion slot 39 of the subdivision box 34, which is to be detected by the pack sensor 157, is adjustable as desired. For example, even when a portion of the medicine pack 2 slightly protrudes from the insertion slot 39 of the subdivision box 34, a protruding portion of the medicine pack is so little that it could be ignored. For this reason, the degree of protrusion to be detected by the pack sensor 157 does not have to be set such that a protruding portion of the medicine pack 2 blocks the detection light L as long as when there is little possibility that the medicine pack 2 gets caught and torn inside or outside the medication support apparatus.

As illustrated in FIG. 5A and FIG. 5B, as the suction holding of one of the medicine packs 2 by the pair of suction pads 52 is released, the medicine pack 2 conveyed by the conveyor 90 to a position substantially directly above corresponding one of the subdivision boxes 34 of the medicine dispensing tray 30 inserted into the subdivision box 34 through the insertion slot 39 of the subdivision box 34.

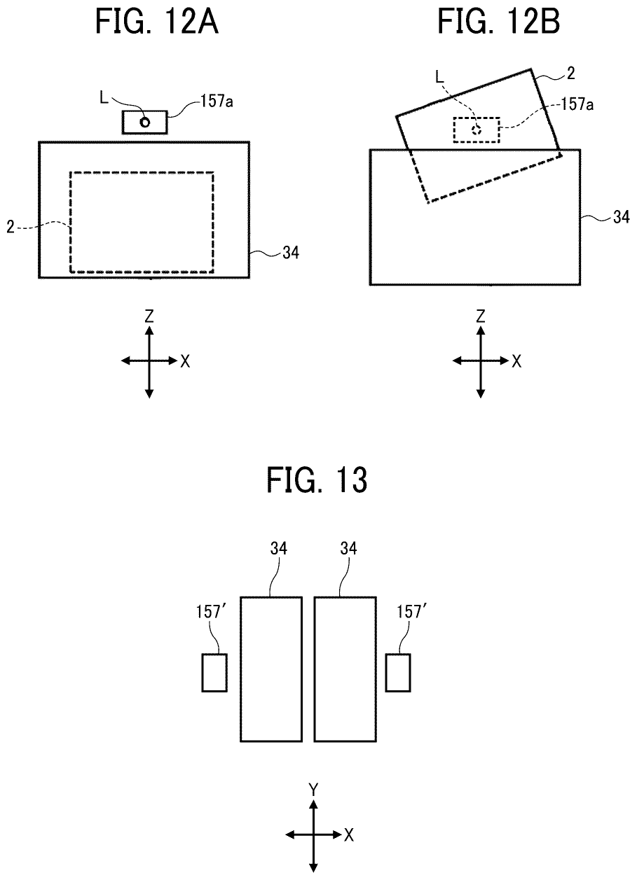

When the medicine pack 2 is appropriately placed inside the subdivision box 34, as illustrated in FIG. 12A, the medicine pack 2 enters the subdivision box 34 deep enough not to block the detection light L. For this reason, the detection light L is incident on the light receiver 157b of the pack sensor 157, and the sensor output that indicates the radiation intensity of light received by the light receiver 157b is at a high (H) level. Accordingly, when it is confirmed that the sensor output is at a high (H) level, the determination processor 159 of the controller 150 that obtains the output from the pack sensor 157 can determine that the medicine pack 2 is appropriately placed inside the subdivision box 34.

By contrast, for example, when the medicine pack 2 that is released from the pair of suction pads 52 of the conveyor 90 to be inserted through the insertion slot 39 of the subdivision box 34 gets caught by the outer edge of the insertion slot 39 or gets caught at some midpoint inside the subdivision box 34, as illustrated in FIG. 12B, a portion of the medicine pack 2 may protrude from the insertion slot 39. When a portion of the medicine pack 2 is placed protruding from the insertion slot 39 as described above, a protruding portion of the medicine pack 2 may get caught by something, and the medicine pack 2 may be torn, for example, while the medicine dispensing tray 30 is being taken out from the third gate 43 of the medication support apparatus 200 or after the medicine dispensing tray 30 is taken out from the third gate 43 of the medication support apparatus 200. For example, the medicine pack 2 may be dropped off from the subdivision box 34 and may fall off while the medicine packs 2 are being taken out from the medication support apparatus 200 or after the medicine packs 2 are taken out.

In the present embodiment, when a portion of the medicine pack 2 is placed protruding from the insertion slot 39 as described above, a protruding portion of the medicine pack 2 blocks the detection light L incident on the light receiver 157b of the pack sensor 157, and the sensor output that indicates the radiation intensity of light received by the light receiver 157b is at a low (L) level. For the above reasons, when it is confirmed that the sensor output is at a low (L) level, the determination processor 159 of the controller 150 that obtains the output from the pack sensor 157 can detect a positioning error where a portion of the medicine pack 2 protrudes from the insertion slot 39 of the subdivision box 34.

In the present embodiment where associated medicine packs are inserted into corresponding one of the multiple subdivision boxes 34 placed in the medicine dispensing tray 30 and are arranged therein, as illustrated in FIG. 10, the detection light L may pass through all the upper spaces of these insertion slots 39, which correspond to all the upstream areas in the insertion direction of the medicine packs, along the row of the multiple subdivision boxes 34. In other words, the phototransmitter 157a is placed at one end of the row of each one of the subdivision boxes 34, the light receiver 157b is placed at the other end of the row of each one of the subdivision boxes 34, and the detection light L that is emitted from the phototransmitter 157a and has passed through all the upper spaces of the insertion slots 39 of these subdivision boxes 34 is received by the light receiver 157b.

More specifically, as illustrated in FIG. 1A and FIG. 1B, when the medicine dispensing tray 30 in which the subdivision box 34 is placed in each one of the twenty (4×5) rooms 33 is used, as illustrated in FIG. 1A, the phototransmitter 157a is placed at the left end of the row of each one of the five subdivision boxes 34 that are arrayed in the X-axis direction, the light receiver 157b is placed at the right end, and the detection light L passes through all the upper spaces of the insertion slots 39 of these five subdivision boxes 34. In the example described above with reference to FIG. 1A or FIG. 1B, the subdivision boxes 34 are arrayed in four rows. Accordingly, as illustrated in FIG. 1B, the phototransmitter 157a and the light receiver 157b are arranged as a pair for each of the rows, and four pack sensors 157-1 to 157-4 are arranged in total.

Due to such a configuration as described above, when a positioning error is detected in any one of the subdivision boxes 34 on the medicine dispensing tray 30, a positioning error can be detected based on the outputs from corresponding one of the pack sensors 157-1 to 157-4. In such a configuration, in what row a positioning error is detected in the subdivision boxes 34 can be specified based on the outputs from the pack sensors 157-1 to 157-4, but in what row and which one of the subdivision boxes 34 a positioning error is detected cannot be specified. However, according to such a configuration, compared with a configuration where the pack sensor 157 is placed at each one of the subdivision boxes 34 on a one-by-one basis such that in which one of the subdivision boxes 34 a positioning error is detected can be specified based on the sensor output, the number of sensors can be reduced, and a relatively simple configuration can be achieved.

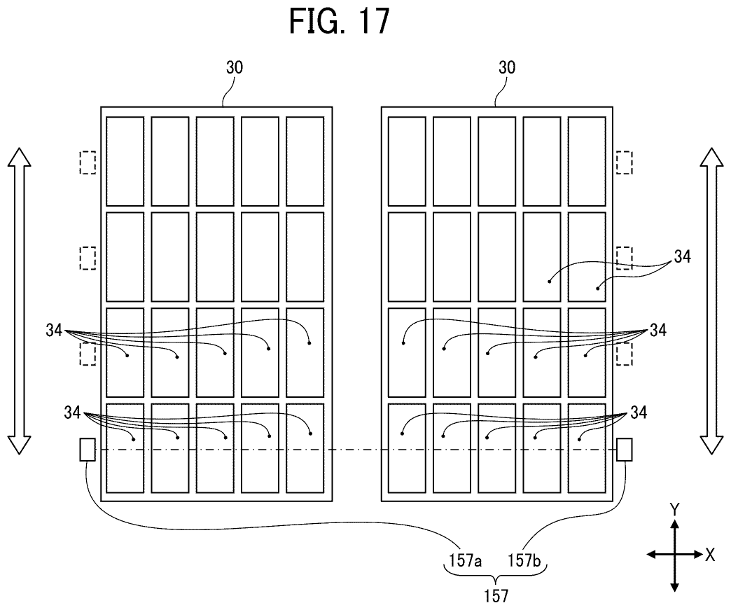

In such an example configuration, the pack sensors 157-1 to 157-4 are arranged at the four rows of the subdivision boxes 34, respectively. However, no limitation is indicated thereby. For example, as illustrated in FIG. 17, a driving mechanism or actuator that is an example of a mover and moves the single pack sensor 157 may be arranged to move the pair of pack sensors 157 sequentially to detecting positions in a plurality of columns, and the detection light L may be made pass through the upper spaces of the insertion slots 39 of the subdivision boxes 34 in a plurality of columns to detect a positioning error sequentially in each row.

In other words, a first operation is performed, and then a second operation is performed. In the first operation, the phototransmitter 157a and the light receiver 157b of the pack sensor 157 are moved to the first fixed position corresponding to a pair of ends of the first row, and the detection light L is emitted from the phototransmitter 157a and then is received by the light receiver 157b. In the second operation, the phototransmitter 157a and the light receiver 157b of the pack sensor 157 are moved by the driving mechanism to the second fixed position corresponding to a pair of ends of the second row, and the detection light L is emitted from the phototransmitter 157a and then is received by the light receiver 157b. These operations are sequentially performed at each row.

For example, the driving mechanism may be a driver that is additionally provided to move the pack sensor 157, or may be an already-existing driver that moves the pack sensor 157 through the connection established by a clutch.

When the light receiver 157b is configured to deal with all the rows in such a configuration, for example, when the light receiver 157b is long enough to receive the detection light L from all the columns, only the phototransmitter 157a of the pack sensor 157 may be moved by the driving mechanism.

When the light receiver 157b is configured to deal with all the columns, for example, when the light receiver 157b is long enough to receive the detection light L from all the columns, the phototransmitter 157a of the pack sensor 157 may be a scanning sensor to be moved from a fixed position such that the irradiation direction of the detection light L swings or oscillates. Due to such a configuration, the detection light L passes through the detection fields, i.e., the upper spaces of the insertion slots 39 of the subdivision boxes 34 in a plurality of columns.

When the detection light L is emitted to only some of the detection field, i.e., an upper space of the insertion slot 39 of the subdivision box 34, for example, when the detection light L is emitted to only a central portion of the detection field in the Y-axis direction as illustrated in FIG. 10, there may be some cases in which the medicine pack 2 that is protruding only into a space or field not included in such some of the detection field cannot be detected. In order to avoid such cases, it is desired that the entirety of the detection field be irradiated with the detection light L.

For example, the above scanning sensor is moved such that the irradiation direction of the phototransmitter 157a swings or oscillates and the detection light L scans the entire range of each one of the detection fields. By so doing, the entirety of each one of the detection fields can be irradiated with the detection light L.

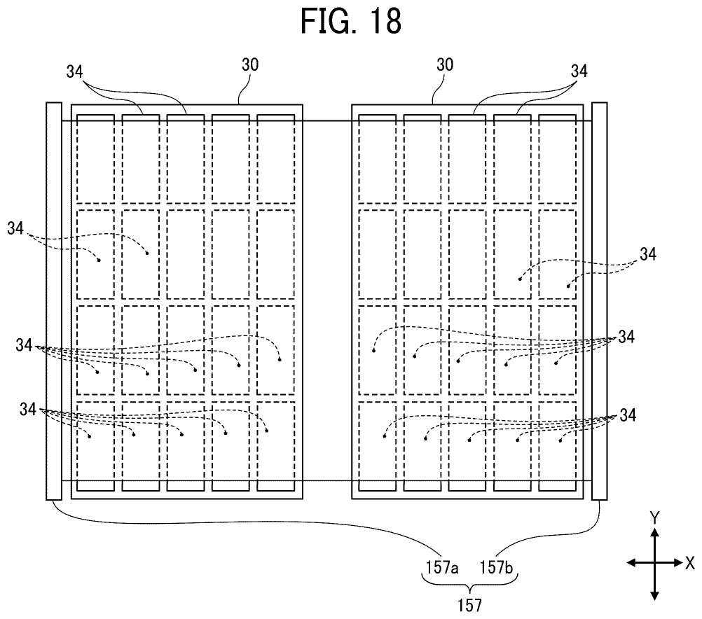

For example, a pair of so-called light-curtain sensors in which the phototransmitter 157a and the light receiver 157b are configured to deal with all the columns may be adopted. For example, as illustrated in FIG. 18, the phototransmitter 157a is made long along ends of all the rows, the light receiver 157b is made long along the other ends of all the rows, and two or more detection lights L are emitted from the phototransmitter 157a to each one of the rows.

By adopting such a configuration in which the entirety of each one of the detection fields can be irradiated with the detection light L, the medicine pack 2 that is protruding only into a space or field that cannot be detected as the detection light L is emitted to only some of the detection field can be detected, and the blind spots of the sensor can be eliminated. Accordingly, a positioning error can be detected with a high degree of precision.

The pack sensor 157 is an example of a transmissive optical sensor. However, no limitation is indicated thereby. For example, as illustrated in FIG. 13, a reflection optical sensor may be adopted. When a reflection optical sensor is adopted, a phototransmitter and a light receiver can be arranged in the same space with respect to the upper space of the insertion slot 39 of the subdivision box 34. Accordingly, a reflection optical sensor offers a high degree of flexibility in the arrangement of sensors compared with transmissive optical sensors. Due to such a configuration, as illustrated in FIG. 13, when a pack sensor 157′ is to be arranged at each one of the subdivision boxes 34 on a one-by-one basis, reflection optical sensors may be more suitable than transmissive optical sensors.

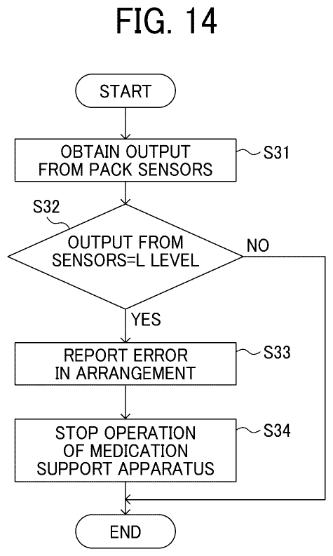

FIG. 14 is a flowchart of the positioning error determination processes (S30) performed by the determination processor 159 of the controller 150.

When the medicine pack 2 that is picked up from one of the cartridges 10 is inserted into corresponding one of the subdivision boxes 34 of the medicine dispensing tray 30 and is appropriately placed therein and the medicine dispensing operation in step S12 is completed, the determination processor 159 of the controller 150 performs the positioning error determination processes (S30). Firstly, in step S31, the determination processor 159 obtain output from each of the pack sensors 157-1 to 157-4 to determines whether any sensor has detected protrusion of the medicine pack 2. More specifically, in step S32, whether any of the outputs obtained from the sensors is at a low (L) level is checked.

When none of the outputs obtained from the sensors is at a low (L) level (NO in step S32), the positioning error determination processes (S30) are terminated on an as-is basis. By contrast, when some of the output obtained from sensors is at a low (L) level (YES in step S32), it is determined that a positioning error where a portion of the medicine pack 2 is protruding is taking place. In step S33, an error is reported by the notification unit 154, and then in step S34, the operation of the medication support apparatus 200 is stopped.

The positioning error determination processes (S30) may be performed after the arrangement of the medicine packs 2 in all the subdivision boxes 34 is completed. However, no limitation is indicated thereby, and the positioning error determination processes (S30) may be performed at a timing in the middle of the medicine dispensing operation in step S12. For example, the positioning error determination processes (S30) may be performed every time the arrangement of the medicine packs 2 in each one of the subdivision boxes 34 is completed. Alternatively, the positioning error determination processes (S30) may be performed every time the arrangement of the medicine packs 2 in of the subdivision boxes 34 in each one of the rows is completed. With such a configuration, a positioning error where a portion of the medicine pack 2 is protruding can be detected in the middle of the medicine dispensing operation in step S12, and an error can be reported in step S33 and the operation of the medication support apparatus 200 can be stopped in step S34. Accordingly, for example, after a positioning error where a portion of the medicine pack 2 is protruding occurs, the pickup device 50 that is an example of a carriage and is being moved by the conveyor 90 can be prevented from being caught by a protruding portion of the medicine pack 2 while the medicine pack 2 is being placed in another one of the subdivision boxes 34.

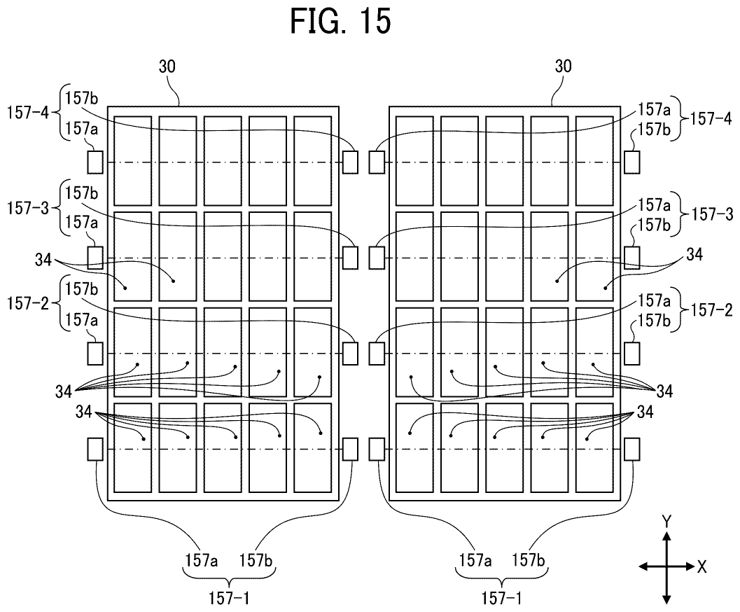

In the medication support apparatus 200, two medicine dispensing trays 30 are arranged as illustrated in FIG. 1A. Accordingly, as illustrated in FIG. 15, four pack sensors 157-1 to 157-4 are attached to each one of the pair of medicine dispensing trays 30. With such a configuration, in which one of the medicine dispensing trays 30 a positioning error has occurred can be specified based on the outputs from the pack sensors 157-1 to 157-4.

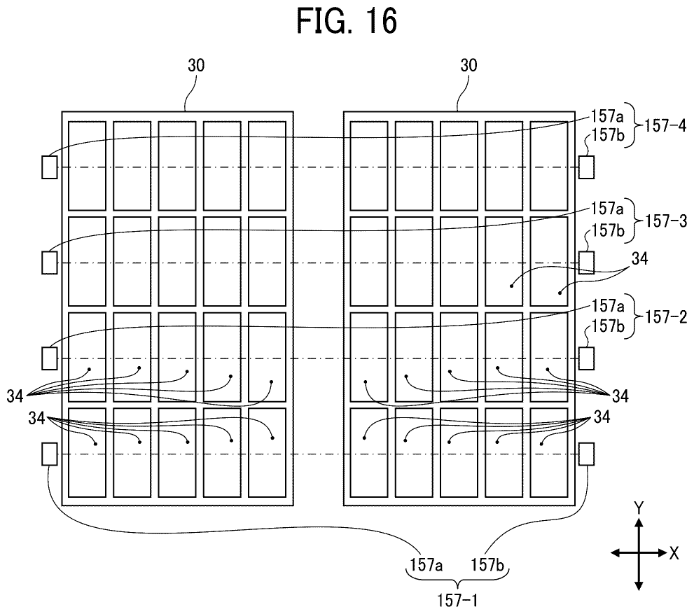

If it is desired that the number of sensors be reduced to achieve a relatively simple configuration, the pack sensors 157-1 to 157-4 may be shared by a plurality of medicine dispensing trays 30. For example, as illustrated in FIG. 16, the pack sensors 157-1 to 157-4 may be shared by two medicine dispensing trays 30. In such a configuration, the detection light L passes through all the detection fields, i.e., all the upper spaces of the insertion slots 39 of the multiple subdivision boxes 34 that are arrayed in the first row of each of the two medicine dispensing trays 30. More specifically, the phototransmitter 157a is placed at one end of one of the two medicine dispensing trays 30 in the first row, and the light receiver 157b is arranged at another end of the other medicine dispensing trays 30 in the first row. This makes up a pack sensor 157-1. With such a configuration, four pack sensors 157-1 to 157-4 are sufficient, while eight pack sensors 157-1 to 157-4 are to be arranged in the example of FIG. 15. With the use of long-range transmissive optical sensors, the pack sensors 157-1 to 157-4 may be shared by three or more medicine dispensing trays 30.

The embodiments described above are given as an example, and advantageous effects are achieved for each of the following aspects given below.

### First Aspect

In a medication support apparatus, a medicine pack is inserted into a medicine tray such as one of the multiple subdivision boxes 34 associated with the medicine pack and is placed therein. The medication support apparatus includes a sensor such as the pack sensor 157 to detect whether the medicine pack is in a detection field including an upstream area in an insertion direction of the medicine pack such as the upper space of the insertion slot 39 over an insertion slot of the medicine tray.

A sensor in a medication support apparatus according to a comparative example is used to detect or determine whether a medicine pack is in a medicine tray, i.e., a downstream area in the insertion direction of medicine packs under an insertion slot of the medicine tray. For this reason, for example, even if a medicine pack gets caught at some midpoint in the medicine tray and a portion of the medicine pack is protruding from one of the insertion slots of the medicine tray, as long as the sensor confirms that the medicine pack is placed inside the medicine tray, it may erroneously be determined that the medicine pack is placed in the medicine tray appropriately. However, if a medicine pack is arranged in such a condition, for example, when the medicine tray is to be taken out from the medication support apparatus afterward, an undesired result may occur. For example, a portion of the medicine pack protruding from one of the insertion slots of the medicine tray is accidentally caught inside or outside the medication support apparatus and the medicine pack is torn. For this reason, a sensor is desired that can detect a positioning error appropriately, for example, when a medicine pack gets caught at some midpoint in the medicine tray and a portion of the medicine pack is protruding from one of the insertion slots of the medicine tray.

In the present aspect, a sensor is used that detects whether a medicine pack is in a detection field including an upstream area in an insertion direction of the medicine pack over an insertion slot of a medicine tray. When a portion of the medicine pack is protruding from one of the insertion slots of the medicine tray, a portion of the medicine pack protrudes to the upstream areas over the insertion slots in the insertion direction of the medicine packs. In such cases, the sensor detects a medicine pack. By contrast, when a medicine pack is inserted into a medicine tray appropriately and is arranged successfully, the medicine pack is not protruding from any one of the insertion slots of the medicine tray, and any protruding portion of the medicine pack is not in the upstream areas over the insertion slots in the insertion direction of the medicine packs. In such cases, the sensor detects no medicine pack. Due to such a configuration according to the present aspect, a positioning error where a portion of the medicine pack is protruding from one of the insertion slots of the medicine tray can be detected appropriately.

### Second Aspect

In the first aspect, the sensor is an optical sensor such as the pack sensor 157 including a light emitter such as the phototransmitter 157a to emit a detection light to the detection field in a direction orthogonal to the insertion direction of the medicine pack and a light receiver such as the pack sensor 157 to receive the detection light that has passed through the detection field.

Due to such a configuration, the sensor can be implemented using a cost-effective simple optical sensor. Moreover, the sensor does not interfere with an operation in which the medicine pack is inserted through the insertion slot of the medicine tray.

### Third Aspect

In the second aspect, a plurality of medicine trays including the medicine tray are further provided, and the medicine pack is inserted into each one of the plurality of medicine trays such as the medicine dispensing tray 30 and is placed therein. In the second aspect, the sensor emits the detection light, using the light emitter, so as to pass through all a plurality of detection fields including the detection field and corresponding to at least two of the plurality of medicine trays such as the multiple subdivision boxes 34 arranged in a row, and receives the detection light that has passed through all the plurality of detection fields, using the light receiver.

Due to such a configuration, the sensor can be configured with a smaller number of optical sensors than in cases where an optical sensor is arranged at every medicine tray on a one-by-one basis.

### Fourth Aspect

In the third aspect, the sensor is configured such that the detection light emitted by the light emitter from a fixed position such as one end in the first row in a fixed direction such as the X-axis direction parallel to the direction where the multiple subdivision boxes 34 are arrayed in a row sequentially passes through the plurality of detection fields and is received by the light receiver.

Due to such a configuration, a sensor can be configured with a relatively simple configuration.

### Fifth Aspect

In the fourth aspect, the sensor includes a mover, which is, for example, a driving mechanism that moves the pack sensor 157, to move the light emitter. In the second aspect, the sensor performs a first operation where the detection light that is emitted from a first fixed position such as one end in the first row by the light emitter sequentially passes through the plurality of detection fields corresponding to at least two of the plurality of medicine trays such as the multiple subdivision boxes 34 arranged in the first row and then is received by the light receiver, and then performs a second operation where the light emitter is moved to a second fixed position such as one end in the second row by the mover and the detection light that is emitted from the second fixed position by the light emitter sequentially passes through the plurality of detection fields corresponding to at least two other of the plurality of medicine trays such as the multiple subdivision boxes 34 arranged in the second row and then is received by the light receiver.

Due to such a configuration, the sensor can be configured with a smaller number of optical sensors.

### Sixth Aspect

In the fourth aspect, the sensor includes a first detecting unit such as the first pack sensor 157-1 in which the detection light that is emitted from a first fixed position such as one end in the first row by a first light emitter such as the phototransmitter 157a of the first pack sensor 157-1 sequentially passes through the plurality of detection fields corresponding to at least two of the plurality of medicine trays such as the multiple subdivision boxes 34 arranged in the first row and then is received by a first light receiver such as the light receiver 157b of the first pack sensor 157-1, and a second detecting unit such as the second pack sensor 157-2 in which the detection light that is emitted from a second fixed position such as one end in the second row by a second light emitter such as the phototransmitter 157a of the second pack sensor 157-2 sequentially passes through the plurality of detection fields corresponding to at least two other of the plurality of medicine trays such as the multiple subdivision boxes 34 arranged in the second row and then is received by a second light receiver such as the light receiver 157b of the second pack sensor 157-2.

Due to such a configuration, a simple sensor that does not require a mover configured to move an optical sensor can be implemented.

### Seventh Aspect

In any one of the third to sixth aspects, the sensor irradiates an entirety of the detection field with the detection light.

Due to such a configuration, the medicine pack that is protruding only into a space or field that cannot be detected as the detection light L is emitted to only some of the detection field can be detected, and the blind spots of the sensor can be eliminated. Accordingly, a positioning error can be detected with a high degree of precision.

### Eighth Aspect

In any one of the third to seventh aspects, a determination processor to deal with a positioning error where the medicine pack protrudes from the insertion slot of the medicine tray when the sensor performs a predetermined detection but the light receiver does not receive the detection light is further provided. For example, the determination processor 159 reports an error, or terminates the operation of the medication support apparatus.

When the sensor performs a predetermined detection but the light receiver does not receive the detection light, the medicine pack is not placed inside the medicine tray appropriately, and the medicine pack protrudes to a detection field, i.e., the upstream areas over the insertion slots of the medicine tray in the insertion direction of the medicine packs. Such a condition is to be detected as a positioning error. According to the present aspect, when such a positioning error is detected, the determination processor 159 deals with an error. For example, the determination processor 159 reports an error, or terminates the operation of the medication support apparatus. Accordingly, a positioning error can be dealt with smoothly.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A medication support apparatus comprising:
a sensor to detect whether a medicine pack to be inserted into a medicine tray associated with the medicine pack is in a detection field including an upstream area in an insertion direction of the medicine pack over an insertion slot of a medicine tray.

2. The medication support apparatus according to claim 1,
wherein the sensor is an optical sensor including:
a light emitter to emit a detection light to the detection field in a direction orthogonal to the insertion direction of the medicine pack; and
a light receiver to receive the detection light that has passed through the detection field.

3. The medication support apparatus according to claim 2, further comprising
a plurality of medicine trays including the medicine tray,
wherein the medicine pack is inserted into each one of the plurality of medicine trays, and
wherein the sensor uses the light emitter to emit the detection light to pass through all of a plurality of detection fields including the detection field and corresponding to at least two of the plurality of medicine trays, and uses the light receiver to receive the detection light that has passed through all of the plurality of detection fields.

4. The medication support apparatus according to claim 3,
wherein the sensor uses the light emitter to emit the detection light from a fixed position in a fixed direction and uses the light receiver to receive the detection light that has sequentially passed through the plurality of detection fields.

5. The medication support apparatus according to claim 4,
wherein the sensor includes a mover to move the light emitter, and
wherein the sensor performs a first operation where the detection light that is emitted from a first fixed position by the light emitter sequentially passes through the plurality of detection fields corresponding to at least two of the plurality of medicine trays and then is received by the light receiver, and then performs a second operation where the light emitter is moved to a second fixed position by the mover and the detection light that is emitted from the second fixed position by the light emitter sequentially passes through the plurality of detection fields corresponding to at least two other of the plurality of medicine trays and then is received by the light receiver.

6. The medication support apparatus according to claim 4,
wherein the sensor includes:
a first sensor including a first light emitter to emit the detection light from a first fixed position and a first light receiver to receive the detection light that has sequentially passed through the plurality of detection fields corresponding to at least two of the plurality of medicine trays; and
a second sensor including a second light emitter to emit the detection light from a second fixed position and a second light receiver to receive the detection light that has sequentially passed through the plurality of detection fields corresponding to at least two other of the plurality of medicine trays.

7. The medication support apparatus according to claim 2,
wherein the sensor irradiates an entirety of the detection field with the detection light.

8. The medication support apparatus according to claim 2, further comprising:
processing circuitry configured to deal with a positioning error where the medicine pack protrudes from the insertion slot of the medicine tray when the sensor performs a predetermined detection but the light receiver does not receive the detection light.
